(19) United States
(12) Patent Application Publication
(10) Pub. No.: US 2015/0211621 A1
(43) Pub. Date: Jul. 30, 2015

(54) SINTERED COMPONENT

(71) Applicants: Miba Sinter Austria GmbH, Laakirchen (AT); Ruebig Gesellschaft m.b.H. & Co. KG., Wels (AT)

(72) Inventors: Christian SANDNER, Gmunden (AT); Guenter RUEBIG, Wels (AT)

(73) Assignees: Ruebig Gesellschaft m.b.H. & Co. KG., Wels (AT); Miba Sinter Austria GmbH, Laakirchen (AT)

(21) Appl. No.: 14/602,017

(22) Filed: Jan. 21, 2015

(30) Foreign Application Priority Data
Jan. 28, 2014 (AT) A 50051/2014

(51) Int. Cl. F16H 55/06; B22F 3/12; B22F 3/26; C23C 8/38; C22C 38/18; C23C 8/32; C23C 8/04; C22C 38/44; C22C 38/22; B22F 5/08; C23C 8/26

(52) U.S. Cl. CPC F16H 55/06; B22F 5/08; B22F 3/12; B22F 3/26; C23C 8/38; C23C 8/26; C23C 8/32; C23C 8/04; C22C 38/44; C22C 38/22; C22C 38/18

(57) ABSTRACT

The invention relates to a sintered component (1), in particular an annular sintered component (1), with a toothing (2), wherein the toothing (2) comprises teeth (3) with tooth bases (6) and tooth flanks (4). All of the teeth (3) and tooth bases (6) of the toothing (2) comprise a plasma nitrided or plasma nitrocarburized layer (7), wherein the tooth bases (6) have a tooth base fatigue strength σ_{F lim} according to DIN 3990 of at least 200 MPa.

The invention relates to a sintered component, in particular an annular sintered component, with a toothing, wherein the toothing comprises teeth with tooth bases and tooth flanks. The invention also relates to a method for producing an, in particular annular, sintered component with a toothing which comprises teeth with tooth bases and tooth flanks, in near net-shape or net-shape quality comprising the steps of powder pressing, sintering and hardening.

Nowadays high-strength sintered gears are case-hardened or carbonitrided to achieve the desired strength. In this case carbon or carbon and nitrogen penetrate into the surface, hard martensite is formed and tensions occur. The latter cause warping and for most applications a subsequent step of hard-fine machining is necessary, in particular for the toothing. Said hard-fine machining means additional costs, particularly in the case of ring gears.

The underlying objective of the present invention is to produce the aforementioned sintered component more inexpensively.

Said objective of the invention is achieved with the aforementioned sintered component in that all of the teeth and tooth bases of the toothing have a plasmanitrided or plasma nitrocarburized layer, wherein the tooth base has tooth base fatigue strength σ_{F, lim} according to DIN 3990 of at least 200 MPa. Furthermore, the objective of the invention is achieved by the aforementioned method, in which the hardening is performed by plasma nitriding or plasma nitrocarburization, wherein tooth bases are produced with a tooth base fatigue strength σ_{F, lim} according to DIN 3990 of at least 200 MPa.

It is an advantage in this case that the sintered components can be produced by the method in near net-shape or in particular in net-shape quality. By means of the plasma nitriding or plasma nitrocarburization used for hardening the sintered components any warping caused by processing, which may occur during hardening, can be avoided. Unlike the known gas nitriding during plasma treatment the nitrogen and possibly carbon is not removed via the pores of the sintered component but via its metallic components, whereby warping can be avoided during the hardening of the sintered component. By having a tooth base fatigue strength σ_{F, lim} according to DIN 3990 of at least 200 MPa, in addition to the hard edge area formed on the sintered component surface the dynamic loadability of the sintered gears is also improved, and thereby is at least within the range of the tooth base fatigue strength of hardened sintered components. Surprisingly, in the case of sintered components according to the invention a high tooth base strength can be achieved, even if the area of the tooth base has not previously been compacted. Furthermore, the sintered component can contain less carbon. In this way a calibration step which possibly takes place prior to the plasma treatment can be performed more simply for adjusting the component geometry after sintering.

According to one embodiment variant of the sintered component the tooth flanks have a nitrided or nitrocarburized layer, which have a tooth flank bearing ability y σ_{H, lim} according to DIN 3990 of at least 500 MPa. In this way a sintered component can be provided, the toothing of which not only has improved dynamic properties but also an improved bearing ability of the flanks during the meshing engagement of the toothing of another toothing element.

It is also possible that the nitrided or nitrocarburized layer(s) of the tooth bases and/or the tooth flanks has/have a maximum value of internal compressive stresses selected from a range of 200 MPa to 1500 MPa. In this way there is a further improvement in the fatigue strength of the sintered component, in that bending and torsion stresses of the toothing and the thereby caused tensile stress loads can be counteracted more effectively. In this way the risk of tears forming in the region of the teeth, in particular in the region of the tooth bases, are reduced. At internal compressive stresses of above 1500 MPa there is an increased risk that the component will warp during the plasma nitriding, whereby the advantage of the method, namely the not necessary hard-fine machining of the sintered components after hardening, is at least partly unnecessary. With internal compressive stresses of below 200 MPa the risk of teeth breaking under loading is increased, in particular in the region of the tooth bases.

According to a further embodiment variant the toothing preferably comprises a modulus from a range of 0.3 mm to 3 mm. It was found as part of the invention that the positive effects of plasma nitriding or plasma nitrocarburization described above are surprisingly noticeable with teeth sizes according to a modulus from this range.

It is also preferable if the sintered component is produced from a sintering powder consisting of 0.1 wt. % to 5 wt. % chromium, 0.1 wt. % to 0.8 wt. % carbon, 0 wt. % to 2 wt. % molybdenum, 0 wt. % to 2 wt. % nickel and the remainder iron. Said composition enables an improved diffusion of the nitrogen and possibly the carbon into the sintered component during the plasma nitriding so that the aforementioned effects can be improved. In addition, by means of the content of chromium, particularly if the latter is selected to be close to the upper limit of 5 wt. %, the sintered component can be given a greater strength, in particular a greater hardness. By means of the low amount of carbon, as already explained above, the formability of the sintered component can be improved during a possible calibration step prior to plasma hardening.

It has also been established in tests that it is an advantage for achieving the tooth base fatigue strength according to the above explanations, if the tooth bases are not compacted after the sintering. It is suspected that the distortions usually formed during compaction in the structure of the sintered component act against the production of the tooth base fatigue strength and in particular also the internal compressive stresses. It was established in many experiment sintered components that the compaction of the tooth base area prior to the plasma nitriding or plasma nitrocarburization can worsen the aforementioned mechanical parameters of the sintered component.

Furthermore, it is possible that the tooth flanks (and possibly the tooth heads) are compacted, in particular cold compacted, in order in this way to improve the flank bearing ability of the teeth.

If a compaction of the whole toothing or at least a compaction of the tooth flanks and the tooth bases is performed prior to the plasma nitriding or plasma nitrocarburization, it is an advantage for the above reasons if the tooth flanks are compacted to a greater degree than the tooth bases.

A further improvement of the dynamic loading ability of the toothing, in particular in the region of the tooth bases, can be achieved if the toothing has a nitriding hardness depth according to DIN 50190-3 which is selected from a range of 0.03 mm to 0.6 mm.

It is also an advantage if all of the teeth and tooth bases of the toothing have a continuous connecting layer consisting of one or more iron nitride(s) or iron carbonitride(s) and/or a continuous diffusion area at least in the region of the 30° tangent contact point. By means of the continuous connecting layer on the surface of the sintered component the ceramic character of the surface is obtained over the whole toothing (at least in radial view), whereby the wearing resistance of at least the total radial, in particular the whole surface of the toothing can be improved. In addition by means of the continuous connecting layer the corrosion resistance can be improved. By means of the diffusion area which is continuous at least in the region of the 30° tangent contact point (i.e. in the region of the critical tooth base cross section) the fatigue strength of the toothing, in particular the resistance to bending stresses, can be improved, as the diffusion area has greater internal compressive stresses than the connecting layer. By means of the diffusion layer from the connecting layer to the base material in the core of the sintered component a hardness gradient can be obtained or adjusted. In addition, the diffusion layer has a support effect for the connecting layer.

It should be mentioned in this connection that a connecting layer in terms of the invention is defined as a layer in which iron nitrides and/or iron carbonitrides are present. Said compounds are formed by the reaction of the iron with the nitrogen and/or the carbon. The term “connecting layer” therefore refers to said compounds and not necessarily to a layer which produces a connection to another layer. The latter can apply however, if a further layer is deposited on the surface of the toothing after the plasma nitriding or plasma nitrocarburization.

If the sintered component comprises additional elements, such as those mentioned above, in particular chromium and molybdenum, the latter can also form nitrides which are present in the diffusion layer.

A diffusion layer is defined in terms of the invention to be layer which is formed in particular underneath the connecting layer. The diffusion layer is formed by infusing nitrogen and possibly carbon into the sintered component during the plasma nitriding or plasma nitrocarburization. A diffusion layer is thus a layer in which nitrogen and possibly carbon are incorporated interstitially and/or in the form of nitride deposits into the matrix.

It is also an advantage if the layer thickness of the connecting layer and the layer thickness of the diffusion area and the nitriding hardness depth in the region of the tooth flanks is greater than or equal to the layer thickness of the connecting area and the layer thickness of the diffusion area and the nitriding hardness depth in the region of tooth bases. In this way a toothing can be achieved which has improved dynamic behavior in the region of the tooth bases and also improved bearing ability in the region of the tooth flanks.

According to another embodiment variant the outermost layer of the tooth flanks and the tooth bases can be an oxide layer, whereby the toothing can be oxidized after the plasmanitriding. Thus on the one hand the corrosion resistance of the sintered component can be increased and on the other hand the friction coefficient of the toothing can be reduced.

Preferably, the toothing has a Vickers surface hardness according to EN ISO 4498 which is selected from a range of 500 HV to 1300 HV. In particular, with hardnesses in this range an increase in the mechanical resistance of the sintered component could be achieved.

In addition, it is also an advantage if the sintered component has a core Vickers hardness according to EN ISO 4498 which is selected from a range of 100 HV to 500 HV. By means of the lower core hardness of the sintered component its core is tougher and it can thereby more effectively resist dynamic loads.

Furthermore, the amount by volume of γ′-nitride (Fe₄N) in the connecting layer is greater than the amount of ε-nitride (Fe₂₋₃N). Because of the greater amount of γ′nitride the connecting layer can also have a greater toughness, so that the dynamic loadability of the sintered component can be improved with higher wearing resistance.

For better understanding of the invention the latter is explained in more detail with reference to the following Figures.

In a diagrammatic much simplified representation:

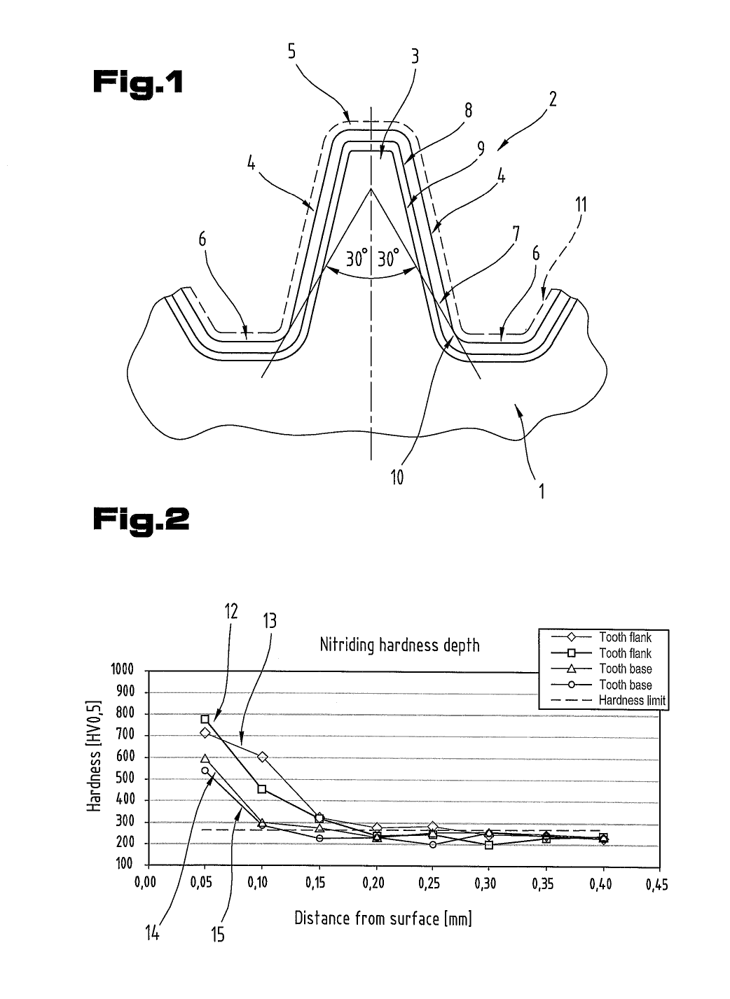

FIG. 1 is a cut-out of a toothing of a gear;

FIG. 2 is a diagram showing the nitriding hardness depth of the gear produced according to the described method according to FIG. 1.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

FIG. 1 is a cross section of a cut-out of a metallic sintered component 1 with a toothing 2. The toothing 2 comprises teeth 3. The teeth comprise tooth flanks 4, tooth heads 5 and tooth bases 6.

With regard to the definition of the areas of the tooth flanks 4, the tooth heads 5 and the tooth bases 6 reference is made to DIN 3998.

A tooth base is defined as the area between the base circle and the beginning of the engaging area of another gear.

The tooth flank is the area of engagement of the other gear. The tooth flank thus adjoins the tooth base.

The tooth head adjoins the tooth flank and is the area between the engaging end of the other gear and the head circle diameter.

The metallic sintered component 1 is designed in particular to be annular and can be a gear wheel, a toothed belt wheel, a gear with internal toothing, for example an internal toothing, for example a ring gear, a sprocket, etc. However, linear configurations are also possible, for example in the form of a gear rack. Furthermore, the sintered component 1 can comprise a spur gearing or helical gearing.

The production of the sintered component 1 is performed in the first procedure according to conventional sintering methods. For this a green compact is produced in a corresponding press mold from a sintering powder, which is produced from the individual (metallic) powders by mixing, whereby the powders can if necessary be used in a pre-alloyed form. Preferably, the green compact has a density greater than 6.8 g/cm³.

The green compact is subsequently dewaxed at the usual temperatures and sintered and then preferably cooled to room temperature. The sintering can be performed for example at a temperature of between 1100° C. and 1300° C.

Alternatively to this the sintering can be performed in two stages, whereby in a first step the green compact is sintered into a brown compact and the latter is then finally sintered by high temperature sintering.

As said methods the method parameters used therein are known from the prior art reference is made to the relevant prior art to avoid repetition.

As the sintering powder from which the sintered component 1 is produced, preferably a powder is used with the following composition:

0.1 wt. % to 5 wt. % chromium

0.1 wt. % to 0.8 wt. % carbon

0 wt. % to 2 wt. % molybdenum

0 wt. % to 2 wt. % nickel remainder iron.

In particular, by means of the proportions of chromium and molybdenum greater hardnesses can be achieved. If the amounts of said elements was too high, i.e. greater than the given range limits, it was found that the nitriding hardness depth reduced with identical plasma nitriding parameters.

If necessary, also conventional processing aids such as pressing aids and/or binding agents can be added in the usual amounts to the sintering powder. Said amounts relate to the total powder mixture. The aforementioned amounts of metallic powder are however related to the total of all metal amounts.

After the sintering the sintered component 1 is hardened to improve its wearing resistance. The hardening is performed by plasma nitriding or plasma nitrocarburizing, whereby in the processing chamber for the sintered component 1 there is at least one nitrogen source and possibly at least one carbon source. The plasma treatment of the sintered component 1 is performed with the following parameters. The sintered components 1 are preferably cleaned prior to heat treatment in the plasma, possibly after previously removing oils and fats in a cleaning installation. Preferably, the cleaning is performed by means of sputtering.

Temperature during the plasma nitriding:

The temperature is selected from a range of 350° C. and 600° C., in particular selected from a range of 400° C. and 550° C. If necessary the temperature can vary over the duration of the method, whereby the temperature remains in the said temperature range.

Duration of the plasma nitriding: 1 hour to 60 hours

Atmosphere during plasma nitriding:

Hydrogen or nitrogen or argon or a mixture thereof can be used for the atmosphere in the plasma chamber, for example a mixture of hydrogen and nitrogen. The ratio of the amounts by volume of hydrogen and nitrogen in said mixture can be selected from a range of 100:1 to 1:100. If necessary, the amounts by volume of hydrogen and nitrogen can vary over the duration of the method, the ratios remaining within said ranges. Additional process gases can be provided, whereby the total proportion in the atmosphere is a maximum of 30 vol.-%.

Voltage:

The electric voltage between the electrodes is selected from a range of 300 V to 800 V, in particular from a range of 450 V to 700 V. In this case it is also possible for the voltage to be varied during the plasma nitriding processing of the sintered components 1.

In this case at least two individual electrodes can be used as well as the sintered component 1 itself as an electrode.

Pressure Range:

The pressure in the processing chamber during the plasma processing of the sintered components 1 can be selected from a range of 0.1 mbar to 10 mbar, in particular from a range of 2 mbar to 7 mbar.

It is possible by means of this method to produce sintered components 1 with a toothing 2 in a near net-shape or net-shape quality, i.e. only a small amount or no subsequent processing needs to be performed, as the sintered components 1 have at least almost their final geometry. In particular, no subsequent machining is necessary.

By means of the plasma nitriding or the plasma nitrocarburization the sintered components 1 are hardened in the areas close to the surface with the formation of a layer 7. In this case the proportion of nitrogen and possibly the proportion of carbon in the sintered components 1 is increased by dispersing nitrogen and possibly carbon into said layer 7. The term “increased” also includes an increase in said proportions starting from 0 wt. % prior to the plasma processing.

The layer 7 extends over all of the teeth 3 of the toothing 2 of the sintered component 1.

The tooth bases 6 of the plasma processed sintered components 1 after performing said method have a tooth base fatigue strength σ_{F, lim} according to DIN 3990 of at least 200 MPa. In particular, the tooth bases 6 have a tooth base fatigue strength σ_{F, lim} according to DIN 3990 from a range of 200 MPa to 500 MPa.

The tooth flanks 4 also comprise the nitrided or nitrocarburized layer 7. After performing the method the tooth flanks 4 have a tooth flank bearing ability σ_{H, lim} according to DIN 3990 of at least 500 MPa.

Preferably however, the tooth flanks 4 have a tooth flank bearing ability σ_{H, lim} according to DIN 3990 of at least 600 MPa. In particular, the tooth flanks 4 have a tooth flank bearing ability σ_{H, lim} , according to DIN 3990 from a range of 600 MPa to 1500 MPa. Said tooth flank bearing ability is achieved by a high degree of hardness and high compressive stresses in the region of the connecting layer 8 and the diffusion layer 9. The tensile stresses produced during use are reduced by the existing compressive stresses, whereby local material strengths are not exceeded.

It has been shown in trials that the aforementioned values for the tooth base fatigue strength and in particular also for the tooth flank bearing ability are achieved more easily if the toothing has a geometry which produces a normal modulus mₙ, which is selected from a range of 0.3 mm to 3 mm, in particular selected from a range of 0.5 mm to 1.5 mm. It suspected that the reason for this is that the weaker glowing of small modulus toothings results in a thin to non-existent brittle connecting layer. The diffusion layer 9, which has internal compressive stresses, is still present.

For the sake of completion it should be mentioned that the modulus according to DIN 868 is defined as a quotient of the part circle diameter in mm and the number of teeth. The part circle diameter is the diameter of a gear in which the tooth division p occurs exactly z times, wherein z is the number of teeth. The tooth division p is the length of a part circular curve between two consecutive identically named flanks (right or left flanks).

Preferably, the plasma nitriding or the plasma nitrocarburization is performed so that all of the teeth 3 and tooth bases 6 of the toothing 2 have a continuous connecting layer 8 consisting of one or more iron nitride(s) or iron carbonitride(s). The connecting layer 8 is part of layer 7. In the connecting layer 8 chemical compounds are produced from iron and nitrogen and possibly carbon.

However, as explained above the connecting layer 8 can be interrupted within the scope of the invention. The diffusion layer 9 extends preferably continuously over all of the teeth 3 and tooth bases 6 of the toothing 2.

A diffusion layer 9 adjoins the connecting layer 8 and is also part of the layer 7. Said diffusion layer 9 is formed underneath the connecting layer 8. In the diffusion layer 9 the nitrogen and possibly carbon are present in a diffused form and as nitrides and/or carbonitrides, i.e. not in the form of chemical compounds as in the connecting layer 8. With respect to the diffusion layer 9 it is preferable if the latter is formed at least in the region of a 30° tangent contact point 10 as a continuous diffusion area.

The 30° tangent contact point 10 is the contact point of the 30° tangent to the rounding of the tooth base 6, as shown in FIG. 1. Said point in a toothing is a critical with regard to the mechanical loading during meshing engagement with another toothing.

The diffusion layer 9 preferably extends completely around the toothing 2 of the sintered component 1, i.e. over the tooth flanks 4, the tooth heads 5 and the tooth bases 6, as illustrated in FIG. 1.

The consistency of the diffusion layer 9 is preferably achieved by increasing the processing pressure.

The consistency of the diffusion layer 9 at least in the region of the 30° tangent contact point 10 is also achieved by preferably increasing the processing pressure.

The connecting layer 8 can have a layer thickness which is selected from a range of 0 μm to 10 μm. For example, the tooth bases 6 can have no connecting layer 8.

The diffusion layer 9 can have a layer thickness, which is selected from a range of 0.03 mm to 0.6 mm.

The layer thickness of the connecting layer 8 and the layer thickness of the diffusion layer 9 can be achieved or controlled by the processing temperature, processing time, processing pressure and the composition of the atmosphere.

According to a preferred embodiment variant the layer thickness of the connecting layer 8 and the layer thickness of the diffusion layer 9 and the nitriding hardness depth in the region of der tooth flanks 4 is greater than or equal to the layer thickness of the connecting layer 8 and the layer thickness of the diffusion layer 9 and the nitriding hardness depth in the region of der tooth bases 6. This can be achieved by a suitable adjustment of the processing pressure and the toothing geometry.

For a definition of the term “nitriding hardness depth” reference is made to DIN 50190-part 3.

Preferably, the toothing 2 has a nitriding hardness depth according to DIN 50190-3 which is selected from a range of 0.03 mm to 0.6 mm. This is achieved by the processing temperature, processing time, processing pressure and the composition of the atmosphere.

According to another embodiment variant of the sintered component 1 the amount by volume of γ′-nitride (Fe₄N) formed in the connecting layer 8 is greater than the amount of ε-nitride (Fe₂₋₃N). This can be achieved by the processing temperature, processing time, processing pressure and the composition of the atmosphere.

According to a preferred embodiment variant of the invention, after the sintering and prior to the plasma nitriding or plasma nitrocarburization only the tooth flanks 4 of the toothing 2 and possibly the tooth heads 5 are compacted, in particular cold compacted. In other words the tooth bases 6 are not compacted after the sintering.

The subsequent compaction can be performed for example by rolling the toothing against a master mold, whereby the master mold has a toothing which engages with the toothing 2 of the sintered component 1. The subsequent compaction can however also be performed in a press mold, by which suitable pressure can be exerted onto the tooth flanks.

According to another embodiment variant, the tooth bases 6 can also be subsequently compacted prior to the plasma nitriding or plasma nitrocarburization, in particular cold compacted. In this case however it is an advantage if the tooth flanks 4 and possibly the tooth heads 5 are compacted to a greater degree than the tooth bases 6. In particular, in this embodiment variant the tooth flanks 4 and possibly the tooth heads 5 are compacted at least 0.2 g/cm³ further than the tooth bases 6.

For the subsequent compaction of the tooth flanks 4 and possibly the tooth heads 5 a compaction pressure can be applied which is selected from a range of 300 MPa to 1200 MPa.

For the subsequent compaction of the tooth bases 6 a compaction pressure can be used which is selected from a range of 300 MPa to 1200 MPa.

By means of the subsequent compaction the areas of the tooth flanks 4 close to the surface and possibly the tooth heads 5 have a density, which corresponds to at least to 95% of the density of the solid material (solid density). The areas of the tooth bases 6 close to the surface can have a density which corresponds to at least to 90% of the density of the solid material (solid density).

The subsequent compaction is performed in particular to a depth in the sintered component 1, which is between 0.08 mₙ and 0.2 mₙ, measured from the surface of the sintered component 1. The area of the sintered component 1 below the compacted area, i.e. the core of the sintered component 1, has a core density which corresponds at least approximately to the density of the sintered component 1 after the sintering.

Preferably, the compaction is performed so that the compaction depth, i.e. the layer thickness of the compacted area from the surface, is greater in the region of the tooth flanks 4 or equal to the compaction depth in the region of the tooth bases 6. In this case the compaction depth in the region of the tooth flanks 4 can be selected from a range of 0.08 mₙ to 0.2 mₙ and the compaction depth in the region of tooth bases 6 can be selected from a range of 0 mₙ to 0.1 mₙ.

It is also possible that the sintered component 1 is calibrated after the sintering and prior to the plasma nitriding or plasma nitrocarburization or after plasma nitriding or plasma nitrocarburization. The calibration is used to improve the geometry of the component, i.e. to adjust the actual dimension to the reference dimension. This is not necessary if the sintered component 1 has already been produced in net-shape quality.

During the calibration if necessary an at least partial compaction of the surface of the sintered component 1 can be performed.

It is also possible that the sintered component 1 is oxidized after plasma nitriding or plasma nitrocarburization, so that an oxide layer 11 is formed on the teeth 3 of the toothing 2, in particular the tooth flanks 4, the tooth heads 5 and the tooth bases 6 at least partially and preferably fully. Said oxide layer 11 forms the outermost layer of the sintered component 1 at least in the region of the tooth flanks 4, the tooth heads 5 and the tooth bases 6, as shown in FIG. 1, in which oxide layer 11 is shown by a dashed line.

The oxide layer 11 is preferably formed in the treatment chamber in which the plasma nitriding or plasma nitrocarburization is also performed. In addition, after the plasma nitriding or the plasma nitrocarburization the treatment chamber can be rinsed in order to remove the treatment gases for plasma nitriding or plasma nitrocarburization from the treatment chamber and then an oxygen source can be introduced into the processing chamber. As the oxygen source oxygen-containing media can be used, such as e.g. air, water, N₂O, etc.

Alternatively, after the plasma nitriding or plasma nitrocarburization of the sintered component 1 the rinsing of the processing chamber can be omitted and the oxygen source can be added straight away.

The oxidizing processing of the sintered components 1 can be performed with the following processing parameters:

temperature: 400° C.-600° C.

pressure: max. 1 atm

time: 0.25 h to 5 h

By means of the oxidizing treatment oxides are produced from the metal components of the sintered components 1, for example magnetite (Fe₃O₄) or other iron oxides. However, other oxides can also be produced, for example chromium oxides or mixed oxides.

The production of the oxide layer 11 can however also be performed in a different processing chamber. The sintered components 1 can be cooled after the plasma nitriding or plasma nitrocarburization and conveyed into said other processing chamber.

Preferably, the oxide layer has a layer thickness selected from a range of 1 μm to 5 μm. In particular, the oxide layer can have a layer thickness of 1 μm to 3 μm.

By forming the oxide layer 8 as the outermost layer of the toothing 2 at least in radial direction in some circumstances the connecting layer 8 can be sealed, whereby the construction of a lubricant film that is able to bear loads between the tooth flanks of meshing toothings is facilitated. In this way the bearing ability of the tooth flanks 4 can also be increased. Furthermore, in this way the corrosion resistance of the sintered component and the running-in behavior of the toothing 2 can be improved.

According to another embodiment variant of the sintered component 1 it is possible that the nitrided or nitrocarburized layer(s) 7 of the tooth bases 6 and/or the tooth flanks 4 have a maximum value of the internal compressive stresses, which is selected from a range of 200 MPa to 1500 MPa, in particular from a range of 300 MPa to 1370 MPa.

The internal compressive stresses are determined according to DIN EN 15305:2008.

This is achieved by the distortion of the crystal lattice caused by the forced dissolution of atomic nitrogen and possibly also carbon.

It is also preferable, if the toothing has a Vickers surface hardness according to EN ISO 4498 which is selected from a range of 500 HV to 1300 HV, in particular selected from a range of 750 HV to 1000 HV. This is achieved mainly by precipitation hardening by means of nitriding.

In this way according to another preferred embodiment variant the sintered component 1 has a Vickers core hardness according to EN ISO 4498, which is selected from a range of 100 HV to 500 HV, in particular selected from a range of 200 HV to 400 HV. This is achieved inter alia by the chemical composition of the sintered component 1 and/or the compaction density, etc.

By means of the aforementioned method sintered components 1 can be produced which even without subsequent compaction after sintering have a high tooth base strength. It is thus also possible to use sintering powders which have a lower proportion of carbon than would be necessary to obtain a specific hardness. In addition, on the surface of the sintered component 1 high internal compressive stresses can be achieved. However, in addition a hardness gradient can also be set with decreasing hardness in the direction of the interior, i.e. the core area, of the sintered component 1.

Preferably, the density in the tooth bases 6 is equal to the density of the base material after sintering and thus corresponds to the core density.

In addition to having a lower carbon content sintering powders with a higher chromium content that are difficult to process can be used. The chromium content can be between 0.1 wt. % and 5 wt. %.

The end faces of the sintered component 1 are usually not compacted separately.

### Example Embodiment

A spur gear is produced from a sintering powder with the composition 0.5 wt. % Mo, 3 wt. % Cr, 0.25 wt. % C and the remainder Fe.

The sintering powder was compacted at a pressure of about 690 MPa and then sintered at a temperature of 1150° C. under a protective gas atmosphere and then cooled to room temperature.

The spur gear had a modulus of 1 mm.

Prior to the plasma nitriding the surface of the spur gear was cleaned thermally.

Afterwards the spur gear was conveyed into a plasma chamber, the plasma chamber was evacuated, flooded with nitrogen and heated convectively. Prior to commencing the plasma nitriding process the evacuation was performed to the processing pressure and then filled with N₂/H₂ as the processing gas.

The plasma nitriding was performed with the following parameters:

temperature: 520° C.

pressure: 4 mbar

electric voltage: 500 V

time duration: 6 h

Afterwards the spur gear was cooled to room temperature.

FIG. 2 shows the achieved nitriding hardness depth. On the y-axis the Vickers hardness (HV 0.5) is entered. On the x-axis the distance from the surface of the spur gear is entered in mm.

The hardnesses were measured of the right (rear) and the left (front) tooth flank 4 (curves 12 and 13) of a tooth 2 and the adjoining tooth bases 6 (curves 14 and 15).

As shown from the measured curves a hardness gradient is formed, both on the tooth flanks 4 and in the tooth bases 6. In this case the hardness of the tooth flanks 4 is much greater than that of the tooth bases 6.

The tooth base fatigue strength σ_{F, lim} according to DIN 3990 was 350 MPa

Furthermore, the spur gear had a tooth flank bearing ability σ_{H, lim} according to DIN 3990 of 900 MPa.

By means of plasma nitriding a connecting layer 8 surrounding the toothing 2 was formed with a thickness of 0 μm to 5 μm mm, whereby the connecting layer 8 was thinner in the region of the tooth bases 6 than in the region of the tooth flanks 4. The thickness of the diffusion layer 9 was between 0.1 mm and 0.2 mm, wherein here too the diffusion layer 9 was thinner in the region of the tooth bases 6 than in the region of the tooth flanks 4.

The example embodiment shows a possible embodiment variant of the sintered component 1.

Finally, as a point of formality, it should be noted that for a better understanding of the structure of the sintered component 1 the latter and its components have not been represented true to scale in part and/or have been enlarged and/or reduced in size.

### LIST OF REFERENCE NUMERALS

1 sintered component

2 toothing

3 tooth

4 tooth flank

5 tooth head

6 tooth base

7 layer

8 connecting layer

9 diffusion layer

10 30° tangent contact point

11 oxide layer

12 curve

13 curve

14 curve

15 curve

1. A sintered component (1), in particular an annular sintered component (1), with a toothing (2), the toothing (2) comprising teeth (3) with tooth bases (6) and tooth flanks (4), wherein all of the teeth (3) and tooth bases (6) of the toothing (2) have a plasmanitrided or plasma nitrocarburized layer (7), wherein the tooth bases (6) have a tooth base fatigue strength σ_{F, lim} according to DIN 3990 of at least 200 MPa.

2. The sintered component (1) as claimed in claim 1, wherein the tooth flanks (4) have a nitrided or nitrocarburized layer (7), which has a tooth flank bearing capacity σ_{H, lim} according to DIN 3990 of at least 500 Mpa.

3. The sintered component (1) as claimed in claim 1, wherein the nitrided or nitrocarburized layer(s) (7) of the tooth bases (6) and/or the tooth flanks (4) has/have a maximum value of the internal compressive stresses which is selected from a range of 200 MPa to 1500 MPa.

4. The sintered component (1) according to claim 1, wherein the toothing (2) has a modulus in a range of 0.3 mm to 3 mm.

5. The sintered component (1) as claimed in claim 1, wherein the latter is produced from a sintering powder with the following composition:
0.1 wt. % to 5 wt. % chromium
0.1 wt. % to 0.8 wt. % carbon
0 wt. % to 2 wt. % molybdenum
0 wt. % to 2 wt. % nickel
remainder iron.

6. The sintered component (1) as claimed in claim 1, wherein the tooth bases (6), in particular after sintering, have not been compacted.

7. The sintered component (1) as claimed in claim 1, wherein the tooth flanks (4) are compacted, in particular cold compacted.

8. The sintered component (1) as claimed in claim 7, wherein the tooth flanks (4) are compacted to a greater degree than the tooth bases (6).

9. The sintered component (1) as claimed in claim 1, wherein the toothing (2) has a nitriding hardness depth according to DIN 50190-3 which is selected from a range of 0.03 mm to 0.6 mm.

10. The sintered component (1) as claimed in claim 1, wherein all of the teeth (3) and tooth bases (6) of the toothing (2) have a continuous connecting layer (8) made from one or more iron nitride(s) or iron carbonitride(s) and/or a diffusion area (9) which is continuous at least in the region of the 30° tangent contact point (10), in particular a diffusion area (9) that is continuous over all of the teeth (3) and tooth bases (6) of the toothing (2).

11. The sintered component (1) as claimed in claim 10, wherein the layer thickness of the connecting layer (8) and the layer thickness of the diffusion area (9) and the nitriding hardness depth in the region of the tooth flanks (4) is greater than or equal to the layer thickness of the connecting area (8) and the layer thickness of the diffusion area (9) and the nitriding hardness depth in the region of tooth bases (6).

12. The sintered component (1) as claimed in claim 1, wherein an outermost layer of the tooth flanks (4) and the tooth bases (6) is an oxide layer (11).

13. The sintered component (1) as claimed in claim 1, wherein the toothing (2) has a surface Vickers hardness according to EN ISO 4498 which is selected from a range of 500 HV to 1300 HV.

14. The sintered component (1) as claimed in claim 1, wherein the latter has a core Vickers hardness according to EN ISO 4498 which is selected from a range of 100 HV to 500 HV.

15. The sintered component (1) as claimed in claim 1, wherein the amount by volume of γ′-nitride (Fe₄N) in the connecting layer (8) is greater than the amount of ε-nitride (Fe₂₋₃N).

16. A method for producing an, in particular annular, sintered component (1) with a toothing (2) which comprises teeth (3) with tooth bases (6) and tooth flanks (4), in near net-shape or net-shape quality, comprising the steps of powder pressing, sintering and hardening, wherein the hardening is performed by plasma nitriding or plasma nitrocarburization, wherein the tooth bases (6) are produced with a tooth base fatigue strength σ_{F, lim} according to DIN 3990 of at least 200 MPa.

17. The method as claimed in claim 16, wherein the toothing (2) is produced with a modulus from a range of 0.3 mm to 3 mm.

18. The method as claimed in claim 16, wherein a powder is used with the following composition:
0.1 wt. % to 5 wt. % chromium
0.1 wt. % to 0.8 wt. % carbon
0 wt. % to 2 wt. % molybdenum
0 wt. % to 2 wt. % nickel
remainder iron.

19. The method as claimed in claim 16, wherein after the sintering only the tooth flanks (4) and possibly the tooth heads (5) are compacted, in particular cold compacted.

20. The method as claimed in claim 16, wherein the tooth flanks (4) are compacted to a greater degree than the tooth bases (6).

21. The method as claimed in claim 16, wherein the toothing (2) is processed after plasma nitriding by oxidization.
